(19) United States
(12) Patent Application Publication
(10) Pub. No.: US 2024/0332577 A1
(43) Pub. Date: Oct. 3, 2024

(54) BOROHYDRIDE-CONTAINING COMPOSITION, HYDROGEN GENERATION SYSTEM AND FUEL CELL SYSTEM

(71) Applicants: TOKYO INSTITUTE OF TECHNOLOGY, Tokyo (JP); University of Tsukuba, Tsukuba-shi, lbaraki (JP); OSAKA UNIVERSITY, Suita-shi, Osaka (JP)

(72) Inventors: Masahiro MIYAUCHI, Meguro-ku, Tokyo (JP); Chika SHIMADA, Meguro-ku, Tokyo (JP); Akira YAMAGUCHI, Meguro-ku, Tokyo (JP); Takahiro KONDO, Tsukuba-shi, lbaraki (JP); Hayato TSURUGI, Suita-shi, Osaka (JP)

(21) Appl. No.: 18/578,782

(22) PCT Filed: Jul. 14, 2022
(86) PCT No.: PCT/JP2022/027687

§ 371 Date: Jan. 12, 2024

(30) Foreign Application Priority Data
Jul. 16, 2021 (JP) 2021-117864

(51) Int. Cl. H01M 8/0606; C01B 3/04; C01B 6/00

(52) U.S. Cl. CPC H01M 8/0606; C01B 3/04; C01B 6/00; C01P 2002/82; C01P 2002/84; C01P 2004/04

(57) ABSTRACT

Provided are a hydrogen boride-containing composition, a hydrogen generation system, and a fuel cell system that achieve further performance improvement of a hydrogen supply source with a hydrogen boride-containing sheet. The hydrogen boride-containing composition contains a hydrogen boride-containing sheet having a two-dimensional network consisting of (BH)ₙ(n≥4, where n is an integer) and an electron donor. At least a portion of the electron donor is supported on the hydrogen boride-containing sheet, electrons of the electron donor are supplied to the hydrogen boride-containing sheet by external stimulus, and hydrogen is generated from the hydrogen boride-containing sheet into which the electrons are injected.

### CROSS REFERENCE TO RELATED APPLICATIONS

This application is a 371 U.S. National Phase of International Application No. PCT/JP2022/027687, filed on Jul. 14, 2022, which claims priority to Japanese Patent Application No. 2021-117864, filed Jul. 16, 2021. The entire disclosures of the above applications are incorporated herein by reference.

### TECHNICAL FIELD

The present invention relates to a hydrogen boride-containing composition and a hydrogen generation system. The present invention also relates to a fuel cell system with the hydrogen generation system.

### BACKGROUND ART

Hydrogen is attracting attention as a clean energy because the substance emitted by combustion or reaction is water. High-pressure cylinders have conventionally been used as a hydrogen supply source, but hydrogen is an explosive gas, and thus technological development of highly safe hydrogen supply systems is being actively pursued.

As a hydrogen supply method for fuel cells, a method using a hydrogen storage alloy has been disclosed (Japanese Unexamined Patent Application Publication No. 2005-063703). In addition, the present inventors recently proposed a hydrogen boride-containing sheet (Kondo T., Miyauchi M. et al., Photoinduced hydrogen release from hydrogen boride sheets, Nature Communications, 10, 4880 (2019), International Patent Publication No. WO 2018/074518) from which hydrogen can be taken out by heat treatment at a relatively low temperature of 200° C. or less. Further, there has been reported a method for easily releasing hydrogen from a hydrogen boride-containing sheet by UV irradiation under mild conditions at room temperature (Japanese Unexamined Patent Application Publication No. 2019-218251).

The hydrogen boride-containing sheet has a high hydrogen storage capacity of approximately 8.5 wt % per unit mass, and is also lightweight, and thus it is desired to further improve the performance of hydrogen boride-containing sheets for practical use as a hydrogen supply source.

The present invention has been made in view of the above circumstances, and an object of the present invention is to provide a hydrogen boride-containing composition, a hydrogen generation system, and a fuel cell system that further improve the performance of a hydrogen supply source with the hydrogen boride-containing sheet and achieve energy saving in hydrogen generation.

### SUMMARY

As a result of extensive investigations, the present inventors have found that the problems of the present invention can be solved in the following aspects, and have completed the present invention.

[1]: A hydrogen boride-containing composition including:
a hydrogen boride-containing sheet having a two-dimensional network consisting of (BH)ₙ(n≥4, where n is an integer); and
an electron donor, in which
at least a portion of the electron donor is supported on a surface of the hydrogen boride-containing sheet, and
electrons of the electron donor are supplied to the hydrogen boride-containing sheet by external stimulus, and hydrogen is generated from the hydrogen boride-containing sheet into which the electrons are injected.
   [2]: The hydrogen boride-containing composition according to [1], in which a LUMO (lowest unoccupied molecular orbital) or conduction band level of the electron donor is more negative than a conduction band level of the hydrogen boride-containing sheet.

[3]: The hydrogen boride-containing composition according to [1] or

[2], in which the electron donor is excited by visible light, and hydrogen is generated from the hydrogen boride-containing sheet by supplying of the excited electrons to the hydrogen boride-containing sheet.

[4]: The hydrogen boride-containing composition according to any one of [1] to [3], in which the electron donor is an organic compound.

[5]: The hydrogen boride-containing composition according to any one of [1] to [4], in which the electron donor has at least one of a carboxy group, a phosphono group, and a sulfonic acid group.

[6]: The hydrogen boride-containing composition according to any one of [1] to [5], including a solvent.

[7]: The hydrogen boride-containing composition according to any one of [1] to [6], further including a hole scavenger.

[8]: The hydrogen boride-containing composition according to [7], in which a redox potential of the hole scavenger is more negative than a HOMO (highest occupied molecular orbital) or valence band level of the electron donor.

[9]: The hydrogen boride-containing composition according to any one of [1] to [8], further including a proton donor.

[10]: The hydrogen boride-containing composition according to [9], in which the proton donor is an acid.

[11]: A hydrogen generation system including the hydrogen boride-containing composition according to any one of [1] to [10], the system including:
a hydrogen boride-containing composition;
a control unit configured to control on/off of external stimulus to the hydrogen boride-containing composition; and
a hydrogen generation unit configured to take out hydrogen to an outside.

[12]: A fuel cell system including the hydrogen generation system according to [11] and a fuel cell to which hydrogen is supplied from the hydrogen generation system.

### Advantageous Effects of Invention

The present invention exhibits such excellent effects that there can be provided a hydrogen boride-containing composition, a hydrogen generation system, and a fuel cell system that further improve the performance of a hydrogen supply source with the hydrogen boride-containing sheet and achieve save energy in hydrogen generation.

### BRIEF DESCRIPTION OF THE DRAWINGS

FIG. 1 is a schematic diagram showing the local structure of a two-dimensional network consisting of (BH)ₙ(n≥4) according to the present embodiment;

FIG. 2 is a schematic diagram showing the local structure of a two-dimensional network consisting of (BH)ₙ(n≥4) according to the present embodiment;

FIG. 3 is a schematic diagram showing the local structure of a two-dimensional network consisting of (BH)ₙ(n≥4) according to the present embodiment;

FIG. 4 is a schematic diagram showing an example of the hydrogen release mechanism of the present composition with a dye;

FIG. 5 is a schematic diagram showing an example of the hydrogen release mechanism of the present composition with a semiconductor;

FIG. 6 is a schematic diagram showing an example of the hydrogen release mechanism of the present composition with a metal;

FIG. 7 is a schematic diagram showing an example of the hydrogen release mechanism of the present composition due to heat;

FIG. 8 is a schematic diagram showing an example of the hydrogen release mechanism of the present composition with a dye and a hole scavenger;

FIG. 9 is a schematic diagram showing an example of the hydrogen release mechanism of the present composition with a dye, a hole scavenger, and a proton donor;

FIG. 10 is a schematic diagram showing another example of the hydrogen release mechanism of the present composition with a dye, a hole scavenger, and a proton donor;

FIG. 11 is a schematic diagram showing an example of a main part of the hydrogen generation system according to a first embodiment;

FIG. 12 is a schematic diagram showing an example of a main part of the hydrogen generation system according to a second embodiment;

FIG. 13 is a schematic diagram showing an example of a main part of the hydrogen generation system according to a third embodiment;

FIG. 14 is a schematic diagram showing an example of a main part of the hydrogen generation system according to a fourth embodiment;

FIG. 15 is a schematic diagram showing an example of a film used in the hydrogen generation system according to a fifth embodiment;

FIG. 16 shows a transmission electron micrograph of the product of Example 1;

FIG. 17 is a graph showing the EELS measurement result of the product of Example 1;

FIG. 18 is a graph showing FT-IR measurement result of the product of Example 1;

FIG. 19 shows UV-Vis spectra of the compositions of Example 1 and Comparative Example 1;

FIG. 20 shows a UV-Vis spectrum of the composition of Example 4;

FIG. 21 shows a TEM image of the composition of Example 5;

FIG. 22 shows a TEM image of the composition of Example 6;

FIG. 23 shows a TEM image of the composition of Example 7;

FIG. 24 shows a TEM image of the composition of Example 8;

FIG. 25 shows a schematic explanatory diagram of an apparatus for evaluating the amount of hydrogen gas released;

FIG. 26 shows a spectrum of irradiation light used in an apparatus for evaluating the amount of hydrogen gas released;

FIG. 27 shows a graph plotting the amount of hydrogen gas released against the visible light irradiation time of the composition such as Example 1;

FIG. 28 shows the action spectrum and UV-Vis absorption spectrum of the composition of Example 1;

FIG. 29 is a graph showing the result of the visible light irradiation intensity and the amount of hydrogen gas released of the composition of Example 1;

FIG. 30 is a graph plotting the amount of hydrogen gas released against visible light irradiation time for compositions such as Example 2;

FIG. 31 shows a graph plotting the amount of hydrogen gas released against visible light irradiation time for the compositions of Examples 1 and 3;

FIG. 32 shows a graph plotting the amount of hydrogen gas released against visible light irradiation time for the composition of Example 1 (effect of post-addition of dye and proton donor);

FIG. 33 shows a graph plotting the amount of hydrogen gas released against visible light irradiation time for the composition of Example 4;

FIG. 34 shows a graph plotting the amount of hydrogen gas released against visible light irradiation time for compositions such as Examples 9 and 10; and

FIG. 35 is a graph plotting the band gaps of the powdered products of Comparative Examples 4 and 5 and Reference Example 1 by Tauc plot.

### DETAILED DESCRIPTION

An example of an embodiment to which the present invention is applied will be described below. Other embodiments are also included within the scope of the present invention as long as they meet the spirit of the present invention. In addition, the sizes and ratios of each member in the subsequent figures are for convenience of explanation, and are not limited thereto.

The hydrogen boride-containing composition (hereinafter also referred to as the present composition) of the present embodiment contains a hydrogen boride-containing sheet that is a sheet-like material and has a two-dimensional network consisting of (BH)ₙ(n≥4, where n is an integer) (hereinafter also referred to as “hydrogen boride-containing sheet”), and an electron donor. At least a portion of the electron donor is supported on the surface of the hydrogen boride-containing sheet. Then, electrons of the electron donor are supplied to the hydrogen boride-containing sheet by external stimulus, and hydrogen is generated from the hydrogen boride-containing sheet into which the electrons are injected.

In this specification, “supported” includes a state in which the material is chemically adsorbed on the surface of the hydrogen boride-containing sheet or a state in which it is physically attached to the hydrogen boride-containing sheet. In addition, the external stimulus may be anything that can apply a certain stimulus to the hydrogen boride-containing composition to supply electrons of the electron donor to the hydrogen boride-containing sheet to generate hydrogen gas. Specific examples thereof include energy ray irradiation such as heat, infrared rays, visible light, ultraviolet rays, and electron beams.

The present composition contains an electron donor that induces generation of hydrogen from the hydrogen boride-containing sheet, and thus the hydrogen generation efficiency can be increased. In addition, selecting the type of the electron donor provides the excellent advantage that external stimulus can be selected according to needs and applications. For example, hydrogen can be released not only by ultraviolet rays but also by visible light, which is abundant in sun light and white lighting, and thus it is expected to have a wide range of applications as a hydrogen-releasing material that utilizes renewable energy and everyday lighting. Although the present embodiment is capable of generating hydrogen at normal temperature and normal pressure, it does not exclude the combined use of a heating process and a pressurizing process. Each component will be explained in detail below.

### [Hydrogen Boride-Containing Sheet]

As used herein, the term “hydrogen boride-containing sheet” refers to a sheet-like material having a two-dimensional network consisting of (BH)ₙ(n≥4, where n is an integer). The two-dimensional network consisting of (BH)ₙ(n≥4) is formed in a molar ratio of boron atoms (B) and hydrogen atoms (H) of 1:1 (refer to Kondo T., Miyauchi M. et al., Photoinduced hydrogen release from hydrogen boride sheets, Nature Communications, 10, 4880 (2019)).

The hydrogen boride-containing sheet may have a two-dimensional network consisting of (BH)ₙ(n≥4), and includes a compound of which main skeleton is a two-dimensional network consisting of (BH)ₙ(n≥4) (for example, a compound in which a dopant is introduced into a part of a two-dimensional network consisting of (BH)ₙ(n≥4), a compound whose ends are sealed with oxides, carbides, nitrides, hydroxides, sulfides, and the like, and a compound with an organic group bonded to the end). Herein, the main skeleton refers to a substance in which the proportion of the hydrogen boride-containing sheet in the compound is 80% or more.

Examples of the dopant include at least one element selected from the group consisting of: elements such as carbon, nitrogen, oxygen, fluorine, phosphorus, sulfur, chlorine, arsenic, selenium, bromine, antimony, tellurium, and iodine; metal elements such as titanium, vanadium, chromium, iron, cobalt, nickel, copper, zinc, cadmium, indium, tin, yttrium, niobium, molybdenum, tungsten, tantalum, and lead; and precious metal elements such as ruthenium, rhodium, palladium, silver, gold, iridium, and platinum.

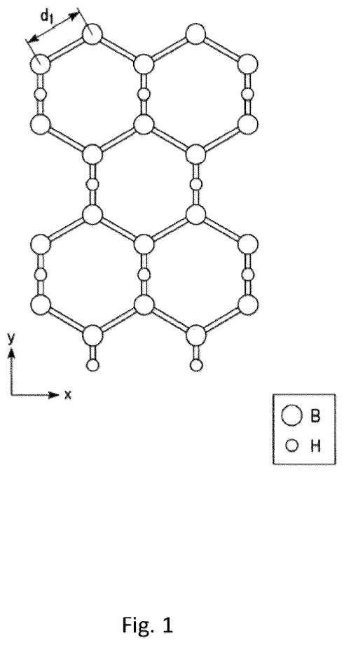

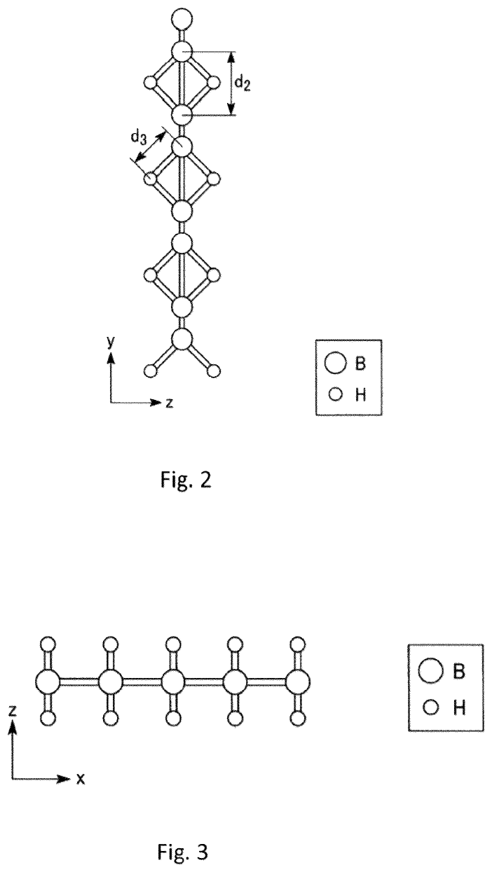

FIGS. 1 to 3 show schematic diagrams of the local structure of a two-dimensional network consisting of (BH)ₙ(n≥4). As shown in FIG. 1, the two-dimensional network has boron atoms disposed in a hexagonal honeycomb shape (hexagons formed by the boron atoms are connected to form a network), and two adjacent boron atoms have sites that bond to the same hydrogen atom. The boron atoms have a honeycomb-like sheet-like hexagonal lattice structure, and one hydrogen atom is bridged to two adjacent boron atoms among the boron atoms of the hexagonal lattice structure, as shown in FIGS. 2 and 3, above and below the sheet, respectively. In addition, two hydrogen atoms are disposed to face each other above and below the sheet-like hexagonal lattice structure. The disposition of hydrogen in hydrogen boride may not have long-range order. In addition, there may be formed such a structure that the bonds between atoms are inclined in the Z direction in FIGS. 2 and 3, or the sheet itself is bent. In addition, not all hydrogen atoms may be necessarily bonded in the form of the bridge.

The hydrogen boride-containing sheet is a thin film-like substance, and may be of a single layer or multiple layers. In the hydrogen boride-containing sheet of the present embodiment, the total number of boron atoms (B) and hydrogen atoms (H) forming the above-described network-like surface structure is 1000 or more.

The bond distance d1 (refer to FIG. 1) between two adjacent boron atoms (B) is, for example, 0.155 nm to 0.190 nm. In addition, when viewed from the Z direction, the bond distance d2 (refer to FIG. 2) between two adjacent boron atoms (B) through one hydrogen atom (H) is, for example, 0.155 nm to 0.190 nm. In addition, the bond distance d3 (refer to FIG. 2) between adjacent boron atoms (B) and hydrogen atoms (H) is, for example, 0.12 nm to 0.15 nm.

The thickness of the hydrogen boride-containing sheet is, for example, 0.2 nm to 10 nm. The length of the hydrogen boride-containing sheet in at least one direction (for example, the length in the X direction or Y direction in FIG. 1) is preferably 100 nm or more. Setting the length in at least one direction to 100 nm or more allows to use the hydrogen boride-containing sheet more effectively as an electronic material, a catalyst carrier material, a catalyst material, a superconducting material, and the like. The size (area) of the hydrogen boride-containing sheet is not particularly limited, and can be formed to any size.

The hydrogen boride-containing sheet of the present embodiment is a substance having a crystal structure. In addition, according to the hydrogen boride-containing sheet of the present embodiment, the bonding force between the boron atoms (B) forming the hexagonal ring and between the boron atom (B) and the hydrogen atom (H) is strong. Therefore, even if forming a crystal (aggregate) formed by laminating multiple layers during production, like graphite, the hydrogen boride-containing sheet of the present embodiment can be easily cleaved along crystal planes and separated (recovered) as a single-layer two-dimensional sheet.

The hydrogen boride-containing sheet is significantly lighter in weight than a hydrogen storage alloy. In addition, it is excellent in safety because it can be used at normal pressure. There is not excluded use under conditions other than normal pressure.

The method for producing the hydrogen boride-containing sheet is not particularly limited. For example, it can be produced by the following method. Specifically, first, a metal diboride having an MB₂ type structure and an ion exchange resin coordinating ions capable of ion exchange with the metal ions constituting the metal diboride are mixed in a polar organic solvent. The M is at least one selected from the group consisting of Al, Mg, Ta, Zr, Re, Cr, Ti, and V. This mixing step can be performed under an inert atmosphere consisting of an inert gas such as nitrogen (N2) or argon (Ar).

As the metal diboride having the MB₂ type structure, one having a hexagonal ring structure is used. For example, there are used aluminum diboride (AlB₂), magnesium diboride (MgB₂), tantalum diboride (TaB₂), zirconium diboride (ZrB₂), rhenium diboride (ReB₂), chromium diboride (CrB₂), titanium diboride (TiB₂), and vanadium diboride (VB₂). It is preferable to use magnesium diboride because of allowing easy ion exchange with an ion exchange resin in a polar organic solvent.

The ion exchange resin coordinating ions capable of ion exchange with the metal ions constituting the metal diboride is not particularly limited. Examples of such an ion exchange resin include: a styrene polymer having a functional group (hereinafter referred to as “functional group α”) that coordinates ions capable of ion exchange with the metal ions constituting the metal diboride; a divinylbenzene polymer having a functional group α; and a copolymer of styrene with functional group α and divinylbenzene with functional group α. Examples of the functional group α include a sulfo group and a carboxy group. Among these, the sulfo group is preferred because of allowing easy ion exchange with metal ions constituting the metal diboride in a polar organic solvent.

An acid may be further added in the mixing step. Examples of the acid include acetic acid, carbonic acid, tartaric acid, malic acid, maleic acid, propionic acid, formic acid, succinic acid, citric acid, oxalic acid, lactic acid, hydrochloric acid, sulfuric acid, and phosphoric acid. Adding an acid can significantly shorten the time for ion exchange between the metal ions easily constituting the metal diboride and the ion exchange resin in a polar solvent.

The polar organic solvent is not particularly limited, and examples thereof include acetonitrile, N,N-dimethylformamide, and methanol.

When an acid is used in the mixing step, the acid is removed as necessary. The method for removing the acid is not particularly limited, but examples thereof include heating, drying under reduced pressure, and precipitation recovery.

Then, the mixed solution is filtered. For example, methods such as natural filtration, vacuum filtration, pressure filtration, and centrifugal filtration are used. The solution containing the product separated and recovered from the precipitate by filtration is dried naturally, dried under reduced pressure, or dried by heating to provide a hydrogen boride-containing sheet having a two-dimensional network, which is the final product.

### [Electron Donor]

In this specification, the term “electron donor” refers to a substance that can supply electrons to a hydrogen boride-containing sheet by external stimulus and generate hydrogen from the hydrogen boride-containing sheet into which the electrons have been injected. It is preferred that the LUMO (lowest unoccupied molecular orbital) or conduction band level of the electron donor is more negative than the conduction band level of the hydrogen boride-containing sheet. Specific examples of the electron donor include light absorbers and heat absorbers. Specific examples thereof include organic compounds. In addition, examples thereof include substances exhibiting metallic properties and substances exhibiting semiconducting properties. Examples of the substance exhibiting metallic properties include metals, metal oxides, metal nitrides, metal carbides, metal oxynitrides, and metal oxycarbides. In addition, examples of the substance having semiconductor properties include semiconductors, metal nitrides, metal sulfides, and metal oxides. These may be used singly or in any combination. When using visible light as an external stimulus, a suitable example of an organic compound includes a dye. Herein, the dye refers to a compound that selectively absorbs visible light in a specific wavelength range, thereby causing color vision.

A functional group may be introduced into the electron donor in order to increase the supporting ratio on the hydrogen boride-containing sheet. Examples of such functional groups include carboxy groups, phosphono groups, and sulfonic acid groups. Among these, carboxy groups are preferred.

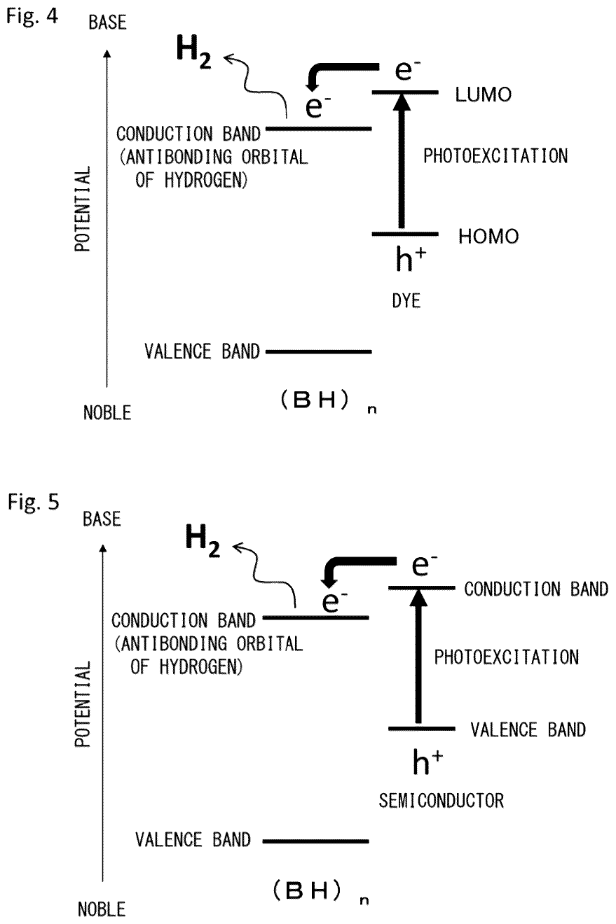

An example of the hydrogen generation mechanism of the present composition when a dye is used as an electron donor will be explained using FIG. 4. However, the present invention is not limited to this mechanism. In the example of FIG. 4, an example will be described in which visible light is used as the external stimulus. Visible light is absorbed by the dye, and this light absorption excites the electrons of the dye from HOMO (highest occupied molecular orbital) to LUMO (lowest unoccupied molecular orbital). This generates holes (h⁺) in the dye. Then, through a step in which the excited electrons are injected into the hydrogen ions at the conduction band level that constitute the antibonding orbitals of hydrogen in the hydrogen boride-containing sheet, a reaction of 2H⁺+2e⁻→H₂↑ occurs, and the hydrogen is considered to be taken out.

An example of the hydrogen generation mechanism when a semiconductor is used as an electron donor will be explained using FIG. 5. However, the present invention is not limited to this mechanism. In this example, an example will be described in which light irradiation is used as the external stimulus. Light is absorbed by the semiconductor, and this light absorption excites electrons from the valence band to the conduction band of the semiconductor. It is considered that hydrogen is released by injection of these excited electrons into hydrogen ions at the conduction band level with antibonding orbitals of hydrogen in the hydrogen boride-containing sheet. Heat may be used as an external stimulus instead of or in combination with light irradiation. In addition, the irradiation wavelength may be appropriately selected depending on the semiconductor used. A plurality of semiconductors having different excitation wavelengths may be used together to utilize a plurality of irradiation wavelengths or irradiation bands.

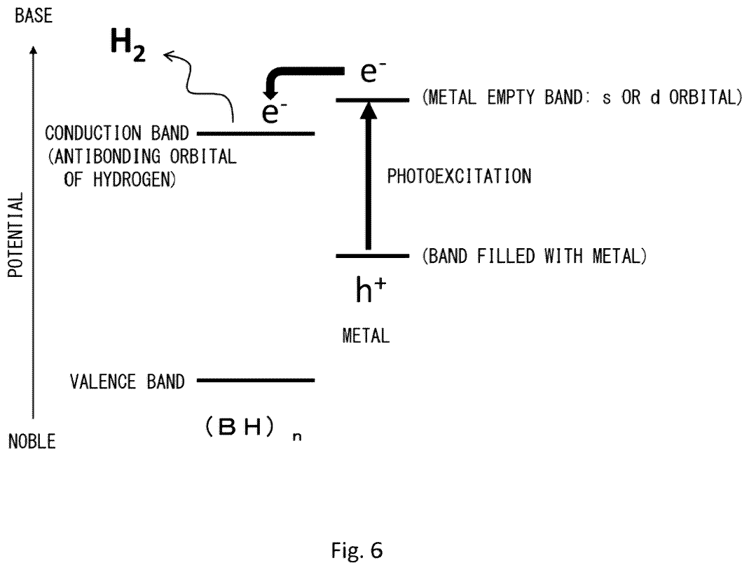

An example of the hydrogen generation mechanism when a metal is used as an electron donor will be explained using FIG. 6. However, the present invention is not limited to this mechanism. In this example, an example will be described in which light irradiation is used as the external stimulus. Light is absorbed by the metal, and this light absorption excites electrons from the metal's HOMO to empty orbits of the metal, such as the s and d orbitals. It is considered that hydrogen is released by injection of these excited electrons into hydrogen ions at the conduction band level with antibonding orbitals of hydrogen in the hydrogen boride-containing sheet. Heat may be used as an external stimulus instead of or in combination with light irradiation. In addition, the irradiation wavelength may be appropriately selected depending on the metal used. A plurality of metals having different excitation wavelengths may be used together to utilize a plurality of irradiation wavelengths or irradiation bands.

The dye is not particularly limited as long as it has a photosensitizing effect. Suitable examples thereof include ruthenium-based sensitizing dyes such as cis-di(thiocyanato)-bis(2,2′-bipyridyl-4,4′-dicarboxylic acid)ruthenium(II) (hereinafter also referred to as “N3”), cis-di(thiocyanato)-bis(2,2′-bipyridyl-4,4′-dicarboxylic acid) ruthenium (II) bis-TBA salt (hereinafter also referred to as “N719”), cis-di(thiocyanato)-bis(2,2′-bipyridyl-4,4′-dicarboxylic acid) ruthenium (II) tetra-TBA salt (hereinafter also referred to as “N712”), tris-tetrabutylammonium salt of tri(thiocyanato)-(4,4′,4″-tricarboxy-2,2′:6′,2″-terpyridine) ruthenium (hereinafter also referred to as “N749”), cis-di(thiocyanato)-(2,2′-bipyridyl-4,4′-dicarboxylic acid) (4,4′-bis(5′-hectylthio-5-(2,2′-bithienyl))bipyridyl)ruthenium (II) mono-tetrabutylammonium salt (hereinafter also referred to as “black dye”), and C106; and iridium-based sensitizing dyes such as tris(2-pyridylphenyl)iridium (III). Further, various organic sensitizing dyes are suitable such as coumarin-based, polyene-based, cyanine-based, hemicyanine-based, thiophene-based, indoline-based, xanthene-based, carbazole-based, perylene-based, porphyrin-based, phthalocyanine-based, merocyanine-based, catechol-based, azo-based, azine-based, and squarylium-based. Further, a donor-acceptor composite sensitizing dye and the like, which are a combination of these sensitizing dyes, may be used. The dyes can be used singly or in combination of two or more. Preferably, the dye contains at least one of N3, N719, N712, and C106.

A substance with metallic properties may have a metallic electronic structure, in which metal electrons are excited by photosensitization or heat, and the excited electrons can be supplied to the hydrogen boride-containing sheet, and the type is not particularly limited. Suitable examples thereof include metals containing at least one selected from the group consisting of gold, platinum, silver, copper, palladium, rhodium, ruthenium, rhenium, iridium, titanium, vanadium, chromium, manganese, iron, cobalt, nickel, zinc, zirconium, niobium, molybdenum, indium, tin, germanium, tantalum, tungsten, osmium, and lead, and alloys thereof. In addition, compounds such as metal carbides and metal nitrides can be used. Examples of the metal carbide include TiC, ZrC, HfC, TaC, and WC. These exhibit metallic properties, and thus can be utilized as electron donors. In addition, examples of the metal nitride include TiN, ZrN, HfN, TaN, and WN. These metal nitrides exhibit metallic properties and all function as electron donors. In addition, metal oxynitrides, metal oxycarbides, and compounds having metallic properties containing oxygen ions can be used.

A substance with semiconductor properties refers to a substance whose electrons can be excited by light irradiation or heat, in which the excited electrons can be supplied to the hydrogen boride-containing sheet, and the type is not particularly limited. Suitable examples thereof include: oxides such as tungsten oxide, bismuth oxide, iron oxide, nickel oxide, cobalt oxide, bismuth vanadate, and calcium iron ferrite; nitrides such as tantalum nitride; sulfides such as cadmium sulfide, zinc sulfide, indium sulfide, tin sulfide, and lead sulfide; and semiconductors such as selenides, tellurides, and phosphides. Semiconductor quantum dots with a diameter of about 5 to 20 nm are preferable from the viewpoint of electron injection efficiency and response wavelength control.

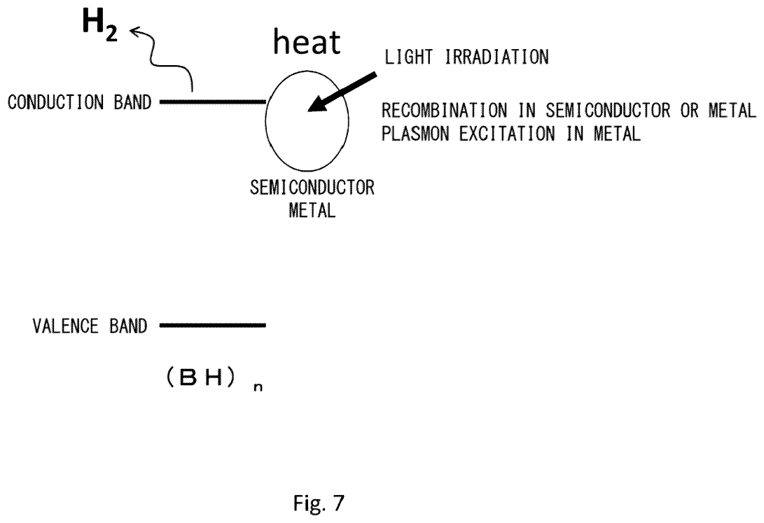

When light absorption occurs in metals (including substances that exhibit metallic properties) and semiconductors (including substances that exhibit semiconducting properties), heat is generated by recombination of excited carriers, and this heat acts as an external stimulus, as shown in FIG. 7, and can induce hydrogen production from the hydrogen boride-containing sheet. In particular, in metals, plasmon absorption occurs and a near field is generated, resulting in a photothermal effect. This heat can promote efficient hydrogen production from the hydrogen boride-containing sheet. When generating hydrogen by optical heating, it is not necessarily required to inject electrons from an electron donor to the hydrogen boride-containing sheet, but using an electron donor can increase hydrogen generation efficiency.

### [Solvent]

The present composition can be used in powder form without using a solvent, but may also be dissolved or dispersed in a solvent. Examples of the solvent include water and organic solvents. The organic solvent is not particularly limited, but examples thereof include solvents such as amide-based solvents, alcohol-based solvents, ester-based solvents, ketone-based solvents, nitrile-based solvents, aromatic-based hydrocarbon solvents, halogenated hydrocarbons, ethers, amides, carbonic esters, hydrocarbons, and nitromethane. Examples of the nitrile-based solvent include acetonitrile, isobutyronitrile, and propylonitrile, and examples of the alcohol-based solvent include methanol, ethanol, and propanol. The solvent may be used singly or in combination of two or more.

### [Hole Scavenger]

The present composition may further contain a hole scavenger. The hole scavenger traps holes generated in the electron donor due to external stimulus and becomes oxidized, thereby preventing deterioration of the electron donor due to self-oxidation. The redox potential of the hole scavenger is preferably more negative than the HOMO (highest occupied molecular orbital) or valence band level of the electron donor.

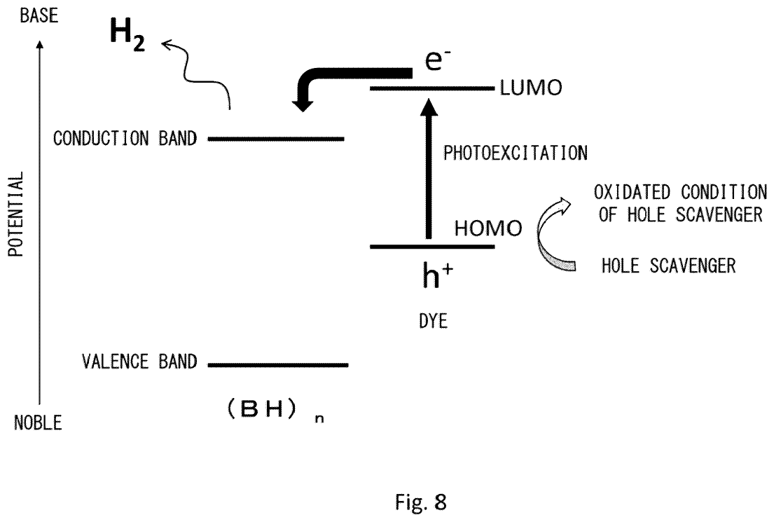

FIG. 8 is a schematic view showing an example of the hydrogen generation mechanism when a hole scavenger is used in the present composition. However, the present invention is not limited to this mechanism. In this example, an example will be explained in which visible light is used as external stimulus. Visible light is absorbed by the dye, and this light absorption excites the electrons of the dye from HOMO (highest occupied molecular orbital) to LUMO (lowest unoccupied molecular orbital). In this case, holes (h+) are generated in the dye, but the hole scavenger supplies electrons to the dye, and thus self-oxidation of the dye can be suppressed. This reaction oxidizes the hole scavenger, and the dye permanently functions as an electron donor. Appropriately replenishing the hole scavenger can increase the hydrogen generation ability while suppressing the amount of dye added.

The hole scavenger is not particularly limited as long as it has the above function. Suitable examples thereof include: triethanolamine (TEOA), ascorbic acid; 1-benzyl-1,4-dihydronicotinamide; benzimidazole derivatives; alcohols such as methanol, ethanol, butanol, and propyl alcohol; aldehydes such as formaldehyde and acetaldehyde; carboxylic acids such as formic acid, acetic acid, and propionic acid; bromine ion, iodine ion, iodate ion, iron ion (Fe²⁺), redox reagents such as ferrocene, photocatalytically active ethylenediaminetetraacetic acid (EDTA); and sodium formate, and polysulfide ion.

The hole scavenger may be reused by reducing the oxidation state in which holes are trapped. An example of the method for reducing the hole scavenger includes a method of mixing a chemical reducing agent such as sodium borohydride, hydrazine, or aldehydes with the present composition. In addition, the hole scavenger can be electrochemically reduced by bringing a negative electrode (not shown) into contact with the present composition in place of or in combination with the above method.

### [Proton Donor]

The present composition may further contain a proton donor. The proton donor refers to a compound that can donate as a proton, and may be one that can be dissolved in a liquid or one that can be dispersed without dissolving. Suitable examples of the proton donor include inorganic acids, organic acids such as carboxylic acids, sulfonic acids, and phenols, alcohols, mercaptans, and 1,3-dicarbonyl compounds. Further, solid acids such as zeolites and ion exchange resins are also suitable. Suitable examples of the proton donor include acids such as formic acid.

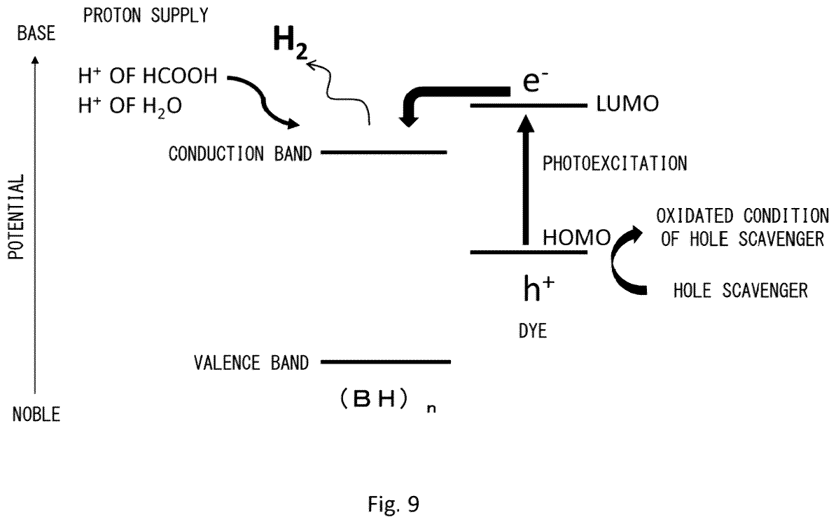

FIG. 9 is a Schematic View Showing an Example of the Hydrogen generation mechanism when a proton donor is used in the present composition. An example of the hydrogen generation mechanism will be explained with reference to the figure. However, the present invention is not limited to this mechanism. In addition to the hydrogen boride-containing sheet, a proton donor is used as a hydrogen supply source. As a result, the hydrogen source losing hydrogen boride is supplied, and the amount of hydrogen released can be increased.

### [Other Additives]

A binder resin, a dispersant, and other high-molecular compounds, or low-molecular compounds may be added to the present composition without departing from the spirit of the present invention. In addition, additives such as antistatic agents, thermally conductive fillers, and flame retardants can be added as appropriate.

### [Hydrogen Boride-Containing Composition]

The present composition can be used as a powder. In addition, a solvent may be added to form a solution, dispersion, or slurry. In addition, the present composition may be formed into a film or a molded body of any shape. The film or molded body can also be a porous body. A laminate may be made by laminating a hole scavenger layer on one major surface of the film, which contains a hydrogen boride-containing sheet and an electron donor supported thereon, and a proton donor layer on the other major surface of the film.

The method for producing the hydrogen boride-containing composition is not particularly limited. It can be obtained by mixing the raw materials of the composition in any order. In addition to preparing the composition previously, the components of the composition may be charged for preparation at the time of use.

### [Sustainable Hydrogen Generation System]

Containing a renewable hole scavenger and a proton donor in the present composition can prevent the hydrogen boride-containing sheet and the electron donor from deteriorating due to external stimuli, thereby allowing to continuously generate hydrogen. That is, even after hydrogen is released from the hydrogen boride-containing sheet, a hydrogen source is supplied from the proton donor. In addition, the electron-hole pairs of the electron donor move to the hydrogen boride-containing sheet and the hole scavenger, respectively to allow to suppress deterioration due to self-oxidation or self-reduction of the electron donor itself.

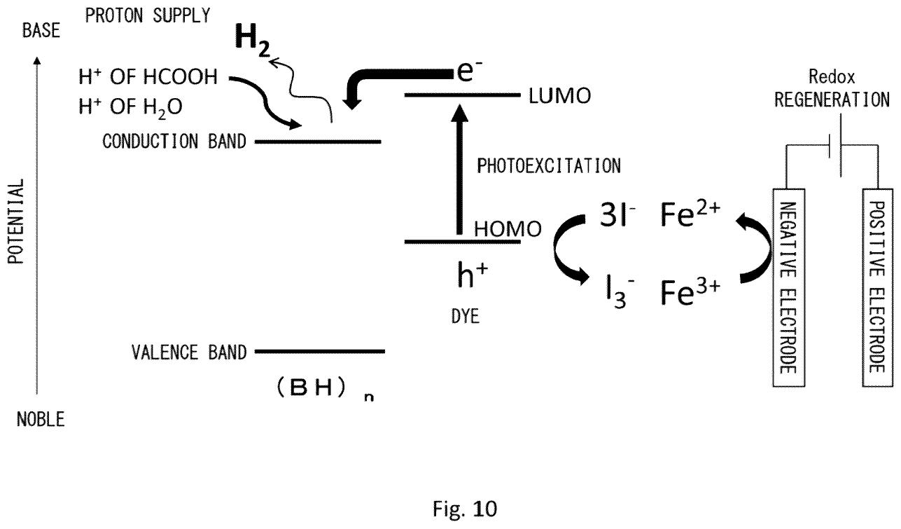

FIG. 10 describes an example of a method for electrochemically reducing a hole scavenger. In the same figure, hydrogen is released using dye and visible light as an external stimulus, and a negative electrode and a positive electrode are placed in a solvent dispersion system in which the present composition is dispersed, and the redox reagent is regenerated in the dark using an external electric field. Thereby, the hole scavenger is electrochemically reduced, and the hole scavenger can be continuously reused. Further, hydrogen release from the hydrogen boride-containing sheet can be supplemented by adding a proton donor.

### [Hydrogen Generation System]

The hydrogen generation system according to the present embodiment utilizes the hydrogen boride-containing composition described above, and includes a hydrogen boride-containing composition, a control unit configured to control on/off of external stimulus to the hydrogen boride-containing composition, and a hydrogen generation unit configured to take out hydrogen to the outside. This hydrogen generation system can be applied to all applications where it is desired to generate hydrogen by external stimulus such as light irradiation. An example of a specific embodiment of the hydrogen generation system will be described below. Each embodiment can be suitably combined.

### First Embodiment

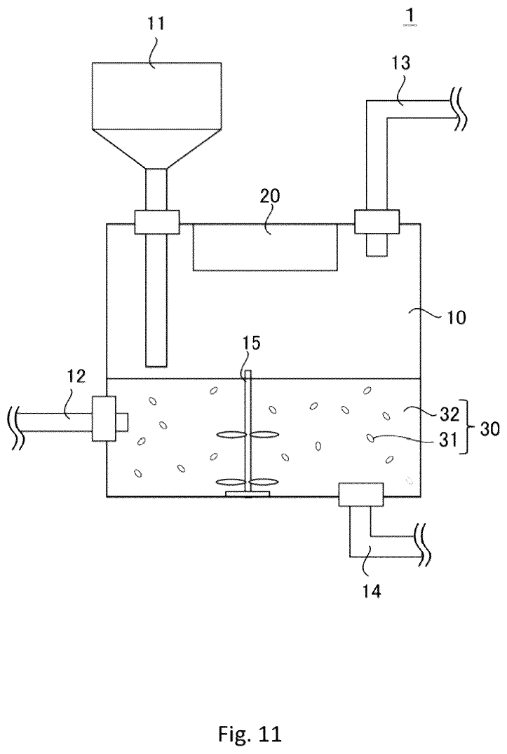

FIG. 11 shows a schematic explanatory view of the hydrogen generation system according to the first embodiment. The hydrogen generation system 1 includes a hydrogen generation unit 10 and an external stimulus control unit 20. The hydrogen generation unit 10 is connected with a raw material supply tank 11, a solvent supply path 12, a gas recovery path 13, and a discharge path 14, and has a container housing a hydrogen boride-containing composition 30 and a stirring unit 15 configured to stir the hydrogen boride-containing composition. In the example of FIG. 11, compositions other than the solvent among the hydrogen boride-containing compositions are supplied from the raw material supply tank 11. The hydrogen boride-containing composition including the solvent may be supplied from the raw material supply tank. In addition, the hydrogen boride-containing sheet, the electron donor, and if necessary, the hole scavenger and proton donor may be supplied separately or in any combination. For example, a tank for supplying an electron donor supported on a hydrogen boride-containing sheet, a tank for supplying a hole scavenger, and a tank for supplying a proton donor may be provided, respectively. Thereby, it is possible to design the optimal material to be supplied depending on the usage situation.

The external stimulus control unit 20 plays a role of supplying an external stimulus at a desired timing to the hydrogen boride-containing sheet 31 supporting an electron donor dispersed in the solvent 32 in the hydrogen generation unit 10. For example, when visible light is used as an external stimulus, the external stimulus control unit has a visible light irradiation function and a function to control on/off of visible light irradiation. That is, the unit has a visible light source and an irradiation control function for this light source. It is also possible to use external light such as sunlight without having a built-in light source. In this case, the external stimulus control unit 20 has a function of controlling transmission and blocking of external light.

Hydrogen generated in the hydrogen generation unit 10 is collected via a gas recovery path 13. According to the hydrogen generation system 1 according to the first embodiment, the amount of hydrogen can be easily adjusted by controlling the conditions of external stimulus (intensity, time, and the like) and the conditions of the hydrogen boride-containing composition (amount, concentration, shape, and the like). Therefore, hydrogen can be supplied by light irradiation without previously storing hydrogen gas in a storage tank. Of course, there is not excluded a configuration in which hydrogen is stored in the hydrogen storage tank via the gas recovery path 13. When such a hydrogen storage tank is provided, there is such an advantage that a desired amount of hydrogen can be taken out instantly.

In order to prevent the amount of hydrogen released from decreasing over time due to the reaction, it is necessary to replace the present composition 30 at an appropriate timing. The discharged composition 30 is subjected to filtration or centrifugation to recover boron-containing by-products, and the solvent can be reused by being guided to the solvent supply path 12 again.

The hydrogen generation system according to the first embodiment allows various modifications. For example, there may be provided a configuration that the hydrogen generation unit 10 is not provided with a container housing the present composition 30 and the stirring unit 15, but provided with a flow path (not shown), the present composition 30 is flowed through the flow path at a desired flow rate, and this flow path is supplied with external stimulus to generate hydrogen.

The hydrogen generation system according to the first embodiment does not require a high pressure tank, and can easily generate hydrogen at normal temperature and pressure. Further, hydrogen generation can be controlled by light irradiation, and thus on/off control of hydrogen generation can be instantaneously and easily performed compared to the heating method. In addition, the mass can be significantly reduced compared to hydrogen storage alloys.

### Second Embodiment

Then, an example of a hydrogen generation system different from the first embodiment will be described. The hydrogen generation system according to the second embodiment differs from the first embodiment in that a gas is used as a dispersion medium and that the composition does not contain a solvent. In the subsequent figures, the same reference numerals are given to element members having the same functions as those described above. In addition, descriptions that overlap with those of the first embodiment will be omitted as appropriate.

FIG. 12 shows a schematic explanatory view of the hydrogen generation system according to the second embodiment. The hydrogen generation system 2 has a hydrogen generation unit 10 and an external stimulus control unit 20. The hydrogen generation unit 10 is connected with a raw material supply tank 11, a gas recovery path 13, a discharge path 14, a gas supply path 16, and the like. In addition, the hydrogen generation unit 10 has an airflow generation unit 17 for causing the present composition to float and diffuse in the gas.

The hydrogen generation unit 10 is configured to be supplied with the hydrogen boride-containing composition 30 via the raw material supply tank 11 and with nitrogen gas or an inert gas via the gas supply path 16 at desired timing. The airflow generation unit 17 plays a role in causing the hydrogen boride-containing composition 30 dispersed in a gas serving as a dispersion medium to float within the hydrogen generation unit 10.

The external stimulus control unit 20 plays a role of supplying an external stimulus at a desired timing to the hydrogen boride-containing composition 30 dispersed in the airflow. The configuration can be similar to that of the first embodiment.

Hydrogen generated in the hydrogen generation unit 10 is collected via the gas recovery path 13. It is configured to recover gas containing a large amount of hydrogen gas by upward displacement. According to the hydrogen generation system according to the second embodiment, controlling the conditions of external stimulus (intensity, time, and the like) and the conditions of the composition (amount, shape, type of electron donor, amount supported, and the like) can adjust the amount of hydrogen generated at normal temperature and normal pressure.

In order to prevent the amount of hydrogen released from decreasing, the residual gas is discharged from the discharge path 14 at an appropriate timing. The recovered residue can be separated into gas and residue by a filter, each of which can be reused.

According to the hydrogen generation system according to the second embodiment, the same effects as in the first embodiment can be obtained. In addition, a method using gas is adopted, thus allowing to achieve further weight reduction than the first embodiment.

### Third Embodiment

In the hydrogen generation system according to the third embodiment, the hydrogen generation unit 10 consists of a thin container, and is different from the embodiments described above in that there is used a thin container in which the light source, which is the external stimulus control unit, is built in the hydrogen generation unit 10.

FIG. 13 shows a schematic explanatory view of the main parts of the hydrogen generation system according to the third embodiment. The hydrogen generation unit 10 has a plurality of thin containers 18. In this thin container 18, an LED light source 21, which is an external stimulus control unit, is built. The hydrogen generation unit 10 is connected with a supply path (not shown) for supplying a dispersion medium (the present composition) in which a hydrogen boride-containing sheet supporting an electron donor is dispersed, a gas recovery path (not shown), and a dispersion medium discharge path (not shown). The dispersion medium may be liquid or gas.

The thin container 18 is configured so that a dispersion medium in which a sheet containing hydrogen boride is dispersed is supplied from a supply path at a desired timing. The hydrogen boride-containing composition 30 dispersed in the hydrogen generation unit is irradiated with light from the LED light source 21 at a desired timing to generate hydrogen.

Hydrogen generated in the thin container 18 is collected via a gas recovery path. According to the hydrogen generation system according to the third embodiment, the same effects as in the first embodiment can be obtained. In addition, using a plurality of thin containers 18 in combination can generate hydrogen gas according to needs. Depending on the application, the hydrogen generation system can be used as a disposable or replaceable cartridge by providing only a gas recovery path and not providing a supply path or a discharge path.

### Fourth Embodiment

The hydrogen generation system according to the fourth embodiment differs from the previous embodiments in that the present composition is supported on a supporting body.

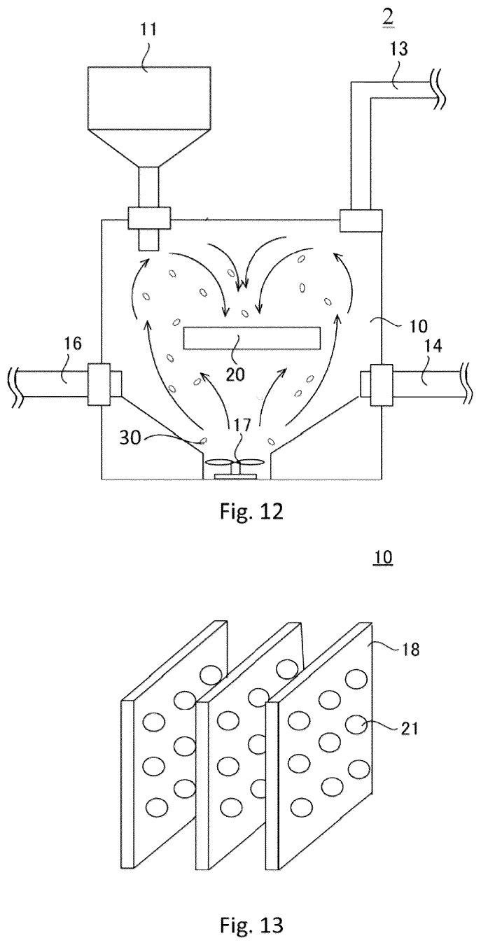

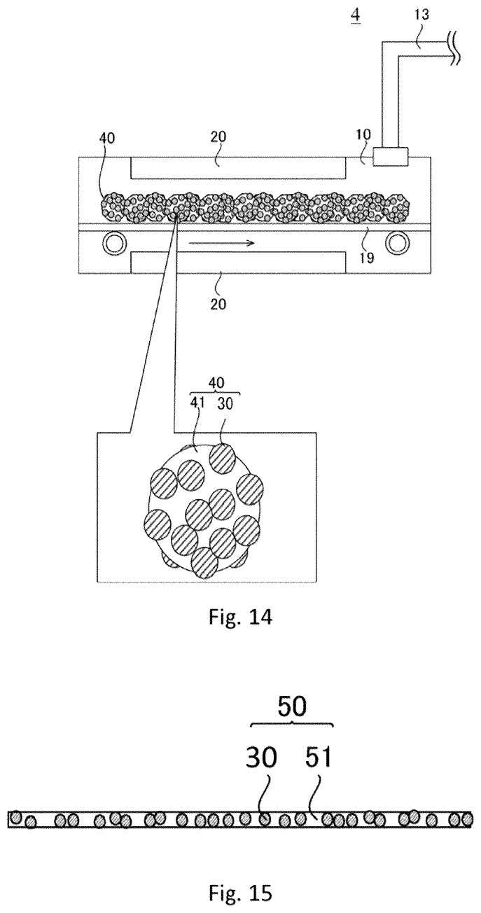

FIG. 14 shows an example of a schematic explanatory view of main parts of the hydrogen generation system according to the fourth embodiment. In the hydrogen generation system 4, a powdery hydrogen boride-containing composition 30 is supported on beads 41 that are transparent to irradiated light. Using the supported beads 40 in which the hydrogen boride-containing composition 30 is supported on the beads 41 can increase the area of the present composition that receives external stimulus to improve the efficiency of hydrogen release.

The hydrogen generation unit 10 includes a conveyor belt 19 configured to convey the supported beads 40 at a desired speed, and the supported beads 40 supplied to the conveyor belt 19 are irradiated with light at a desired timing using an external stimulus control unit 20. The hydrogen generated in the hydrogen generation unit 10 is collected via the gas recovery path 13. For the supported beads 40 on the conveyor belt 19, the light irradiation conditions, the transfer speed of the conveyor belt 19, and the transfer amount of the supported beads 40 are adjusted so that the amount of hydrogen released does not decrease.

The hydrogen generation system according to the fourth embodiment can provide the same effects as in the first embodiment. In addition, the device can be made smaller. Instead of beads, an adhesive sheet, a porous body, a film, and the like may be used as the supporting body.

### Fifth Embodiment

The hydrogen generation system according to the fifth embodiment differs from the previous embodiments in that the powder of the present composition is dispersed in a binder.

FIG. 15 shows a schematic explanatory view of a film used in the hydrogen generation system according to the fifth embodiment. A film 50 is made of a molded body in which powder of the hydrogen boride-containing composition 30 is dispersed in a binder 51. Such a molded body may be formed on a support. Dispersing the hydrogen boride-containing composition 30 in the binder 51 facilitates molding of a desired shape. The binder 51 is preferably a foamable resin or a porous material so as not to hinder hydrogen generation. In addition, when the external stimulus is light, the binder is preferably made of a material that is highly transparent to the light so as not to reduce the hydrogen release efficiency.

According to the hydrogen generation system according to the fifth embodiment, the same effects as in the first embodiment can be obtained. In addition, the present composition to be set in the hydrogen generation unit can be molded into a desired shape.

### [Fuel Cell System]

The fuel cell system according to the present embodiment is equipped with the hydrogen generation system described above as a hydrogen supply source for the known fuel cell. The fuel cell according to the present embodiment can easily supply hydrogen to the fuel cell even at normal temperature without using a high-pressure tank.

### EXAMPLES

### Synthesis Example 1

Based on Kondo T., Miyauchi M. et al., Photoinduced hydrogen release from hydrogen boride sheets, Nature Communications, 10, 4880 (2019), a hydrogen boride-containing sheet having a two-dimensional network consisting of (BH)ₙ(n≥4) was synthesized. Specifically, 500 mg of magnesium diboride (manufactured by Sigma-Aldrich Co. LLC) and 30 mL of a cation exchange resin (manufactured by Organo Corporation) were stirred in acetonitrile at room temperature for 3 days. This solution was filtered through a filter with a pore size of 0.2 m, and the filtrate was dried under reduced pressure at 80° C. to obtain a yellow product.

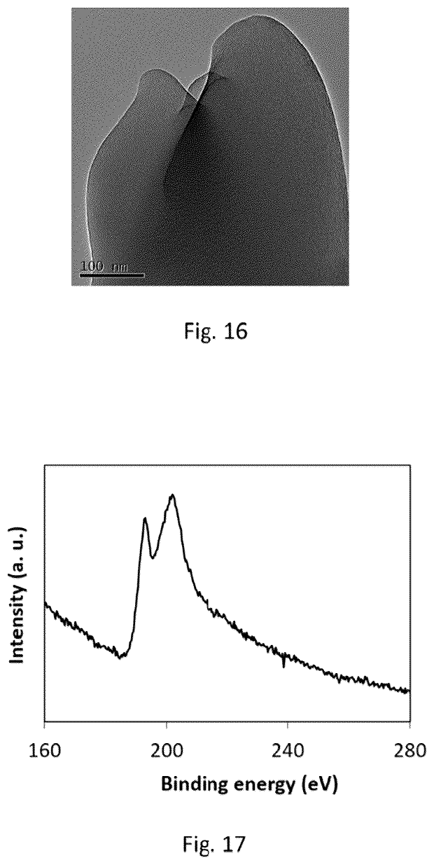

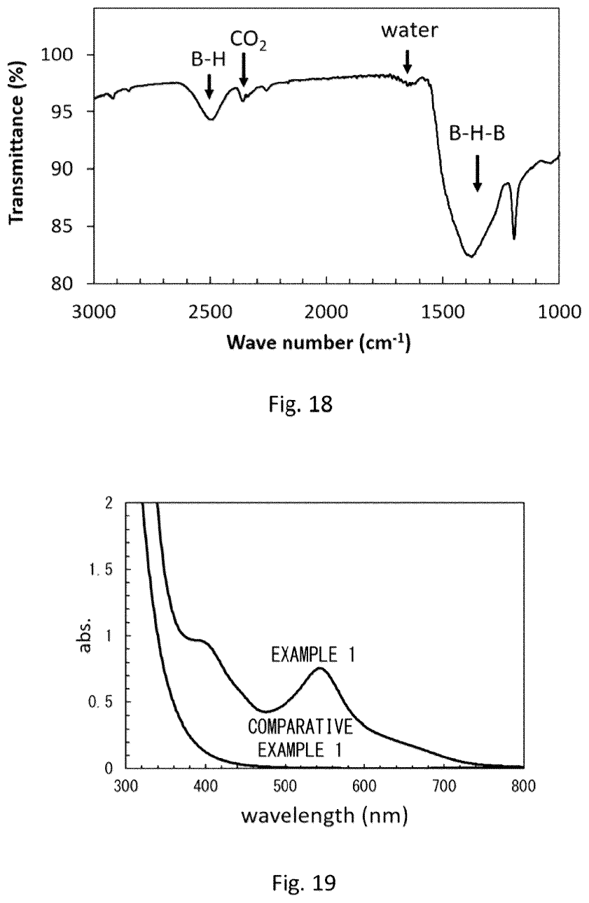

A transmission electron micrograph of the product obtained in Synthesis Example 1 is shown in FIG. 16. As shown in the figure, it was confirmed that it was a sheet-like substance. In addition, the results of electron energy loss spectroscopy (EELS) of this product are as shown in FIG. 17, and peaks divided into 193 eV and 202 eV were confirmed. The former is attributed to the transition from the is orbital to the π* orbital of boron, and the latter is attributed to the transition from the is orbital to the σ* orbital, indicating that boron has a network consisting of two-dimensional sp2 hybrid orbitals. FIG. 18 shows an infrared spectrum (FT-IR) of the product. As shown in the figure, B-H vibration and B-H-B vibration were observed at 2500 cm⁻¹ and 1400 cm⁻¹, respectively, confirming a hydrogen boride-containing sheet having a two-dimensional network.

### Example 1

The hydrogen boride-containing sheet of 2.8 mg obtained in Synthesis Example 1, and 0.2 mg of N3 dye (cis-bis(isothiocyanate)bis(2,2′-bipyridyl-4,4′-dicarboxylate)ruthenium(II)) represented by chemical formula (1) were dispersed in 5 mL of acetonitrile to provide a hydrogen boride-containing composition according to Example 1.

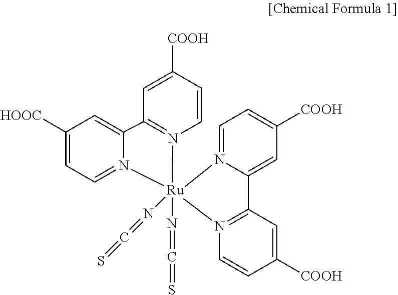

FIG. 19 shows the UV-Vis spectrum of the obtained composition. The figure also shows the UV-Vis spectrum of Comparative Example 1, which will be described later. As shown in the figure, the composition of Example 1 has absorption in a wide visible light range.

### Example 2

The hydrogen boride-containing sheet of 2.8 mg obtained in Synthesis Example 1 and 0.2 mg of N3 dye were mixed to provide a powdery composition according to Example 2.

### Example 3

The hydrogen boride-containing sheet of 2.8 mg obtained in Synthesis Example 1, 0.2 mg of N3 dye, and 2 mL of TEOA (triethanolamine) as a hole scavenger were dispersed in 3 mL of acetonitrile to provide a composition according to Example 3.

### Example 4

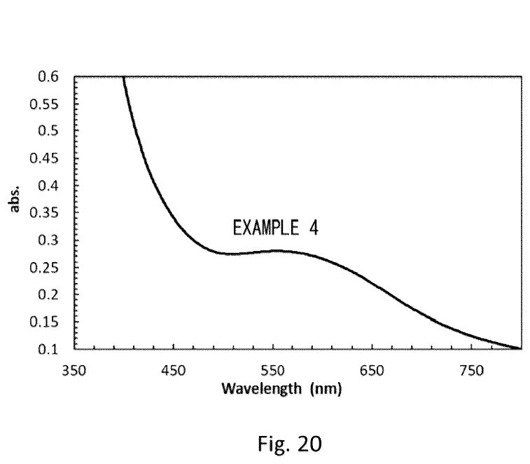

An acetonitrile dispersion (0.05 mol/L) of a hydrogen boride-containing sheet and an acetonitrile dispersion (0.000065 mol/L) of AuCl₃ (manufactured by FUJIFILM Corporation) were mixed. FIG. 20 shows the UV-Vis spectrum one hour after mixing. As shown in the figure, the composition of Example 4 has absorption in a wide visible light range.

### Example 5

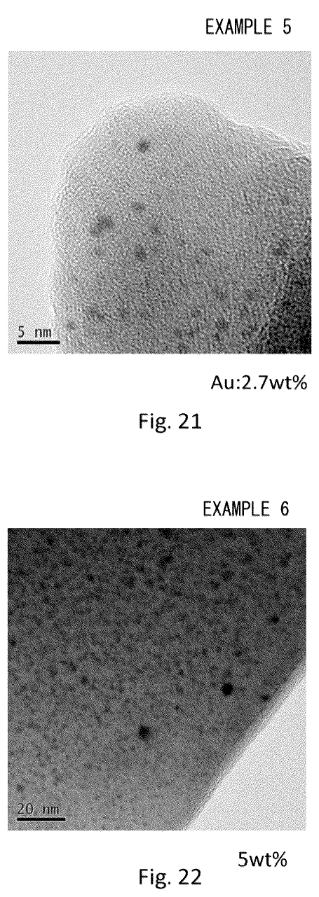

Vacuum drying the composition according to Example 4 provided a powdery composition according to Example 5. In the entire composition according to Example 5, the amount of gold added was 2.7% by mass. A TEM image of the obtained powder is shown in FIG. 21. As shown in FIG. 21, it is found that gold was supported on the hydrogen boride-containing sheet.

### Examples 6 to 8

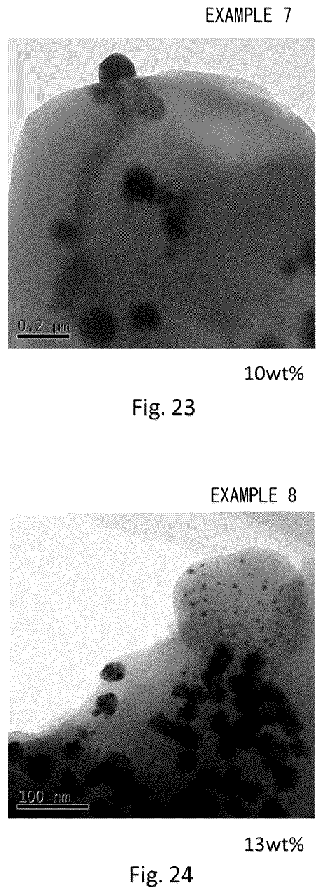

Compositions according to Examples 6 to 8 were obtained in the same manner as in Examples 4 and 5, except that the amount of gold in the total composition was changed to 5, 10, and 13% by mass in that order. TEM images of the powdery compositions of Examples 6 to 8 are shown in FIGS. 22 to 24 in order. In all compositions, it was confirmed that gold was supported on the hydrogen boride-containing sheet.

### Examples 9 and 10

The composition of Example 1 was vacuum dried to provide that of Example 9 in powder form. In addition, a composition synthesized by replacing the dye of Example 1 with 4-4′-bipyrdyl from N3 was vacuum dried to provide that of Example 10 in powder form.

### Comparative Example 1

The hydrogen boride-containing sheet of 2.8 mg obtained in Synthesis Example 1 was dispersed in 5 mL of acetonitrile to provide a composition according to Comparative Example 1.

### Comparative Example 2

N3 dye of 0.2 mg was dispersed in 5 mL of acetonitrile to provide a composition according to Comparative Example 2.

### Reference Example 1

The powder of the hydrogen boride-containing sheet obtained in Synthesis Example 1 is referred to as Reference Example 1.

### Comparative Example 3

Magnesium (Mg) powder, boron (B) powder, and graphite (C) powder are mixed so that the molar ratio of Mg:B:C is 1:2-2x 2x (x may be selected freely), and the mixture was calcined at 900° C. for 48 hours under an inert atmosphere using the powder-in-closed-tube method described in A. Yamamoto, et al. Supercond. Sci. Technol. 17, 921, 2004 to provide a powder doped with carbon in the crystal lattice of MgB₂. In Comparative Example 3, MgB₂ powder was synthesized with an x value of 0.02, that is, a carbon doping amount of 2%.

Then, MgB₂ powder of 500 mg doped with 2% carbon was mixed with 30 mL of a cation exchange resin (manufactured by Organo Corporation) in acetonitrile in the same manner as in Synthesis Example 1, and stirred at room temperature for 3 days. This solution was filtered through a filter with a pore size of 0.2 m, and the filtrate was dried under reduced pressure at 80° C. to provide a product.

### Comparative Example 4

A product of Comparative Example 4 was obtained in the same manner as in Comparative Example 3 except that the value of x was changed to 0.04.

### (Evaluation 1)

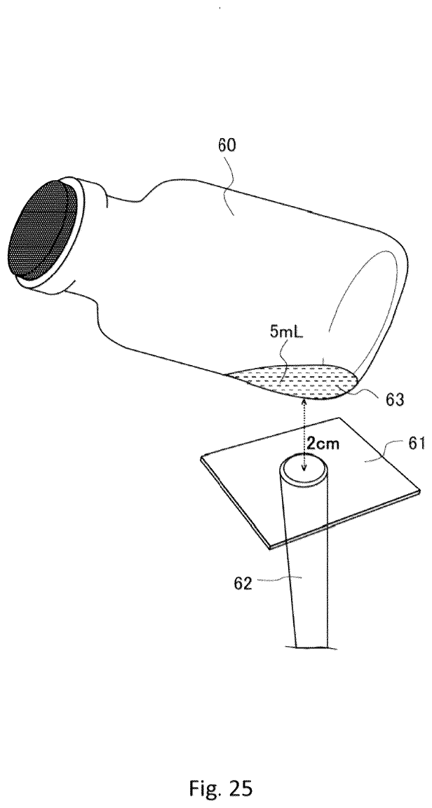

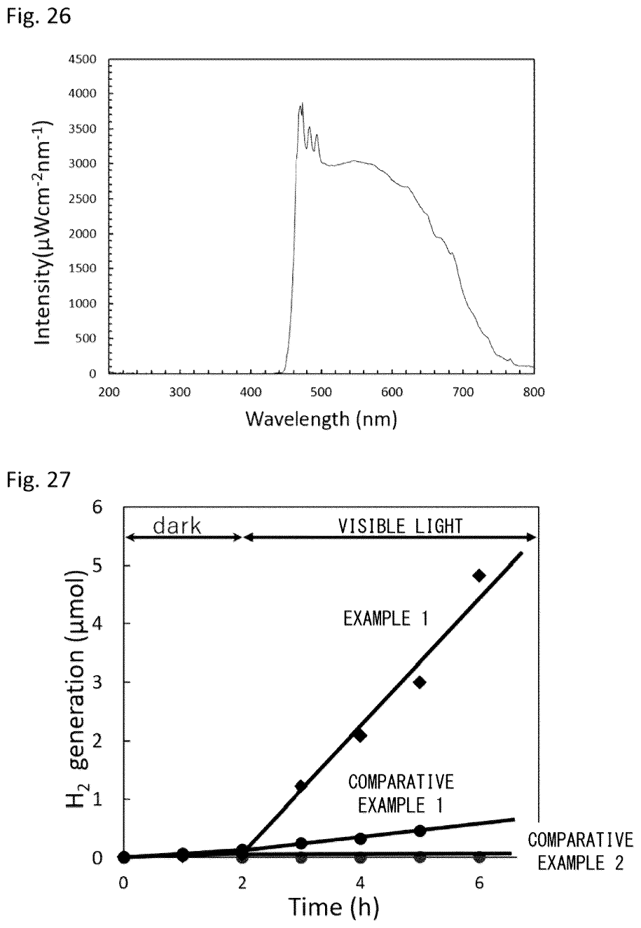

The amount of hydrogen released for the composition obtained in Example 1 was evaluated by the following method. That is, 5 mL of the composition obtained in Example 1 was placed in a closed quartz glass container 60, and as shown in FIG. 25, a light source was installed so that visible light was irradiated onto a measurement sample 63 through the quartz glass plate. The inside of the quartz glass container 60 was made into a nitrogen atmosphere, and the amount of hydrogen gas released was measured by analyzing the gas inside the container using micro GC. The distance between the lower surface of the measurement sample 63 and the visible light source was 2 cm. The measurement sample 63 was left in a dark room for 2 hours, and then irradiated with visible light, and the amount of hydrogen released was measured using a gas chromatograph GC-2010Plus (manufactured by Shimadzu Corporation) set with a barrier discharge ionization detector. A super bright 500 XEF-501S (manufactured by Tokina Corporation, 500 W, 25.0 A) was used as a visible light source, and a cut filter 61 cut off light of 470 nm or less. FIG. 26 shows the spectrum of the irradiated light.

FIG. 27 shows a view in which the amount of hydrogen released is plotted against visible light non-irradiation time (dark) and visible light irradiation time for Example 1 and Comparative Examples 1 and 2. As shown in the figure, it was confirmed that hydrogen was not substantially generated in any of the samples without irradiation, and the composition of Example 1 released a significantly higher amount of hydrogen than Comparative Example 1 by irradiation with visible light. The internal quantum efficiency for the amount of hydrogen released in Example 1 was 4.42%. For the internal quantum efficiency, the number of absorbed photons was calculated from the absorption spectrum of the composition and the spectrum of the light source, and the value was calculated by dividing the number of electrons required for hydrogen production, which is a two-electron reaction.

### (Evaluation 2)

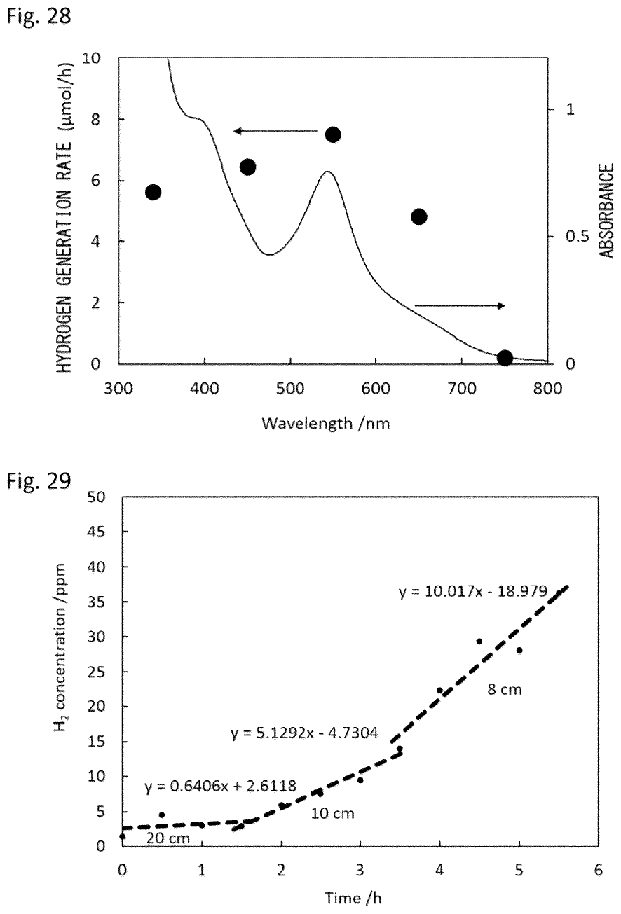

Regarding the composition of Example 1, the hydrogen production rate per hour of light irradiation was measured in the same manner as in Evaluation 1 except that the light source was a monochromatic light source. For the monochromatic light source, the visible light source, super bright 500 XEF-501S (manufactured by Tokina Corporation, 500 W, 25.0 A) described in Evaluation 1 was used, and the sample was irradiated through various bandpass filters (wavelengths: 757, 650, 550, 450, and 340 nm). FIG. 28 shows these results (action spectrum) and the results of superimposing the UV-Vis absorption spectrum of the composition of Example 1. As shown in the figure, the action spectrum and absorption spectrum matched, indicating that hydrogen production was induced by photoexcitation of the composition of Example 1.

### (Evaluation 3)

Regarding the composition of Example 1, the amount of hydrogen released was measured in the same manner as in Evaluation 1, except that the distance between the light source and the sample was changed over time, and 3 mL of the composition obtained in Example 1 was used. The results are shown in FIG. 29. As shown in the figure, it was confirmed that the amount of hydrogen released changed depending on the irradiation distance from the light source, that is, the light intensity.

### (Evaluation 4)

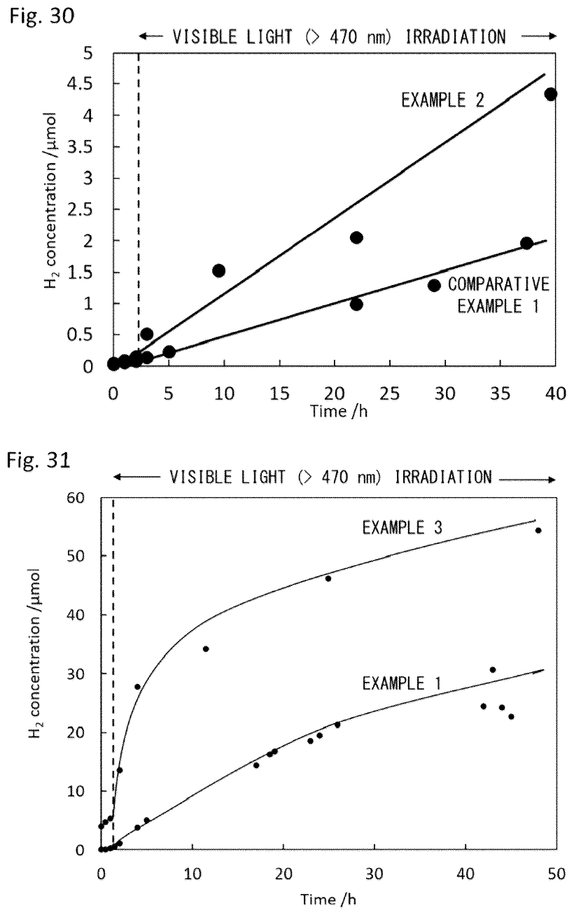

Using the device shown in FIG. 25, the amount of hydrogen released from the powdery composition of Example 2 was measured. The results are shown in FIG. 30. As shown in the figure, it was confirmed that hydrogen was released even in a powder system.

### (Evaluation 5)

Using the device shown in FIG. 25, the amount of hydrogen released from the composition of Example 3 was measured. Specifically, a 5 mL sample was placed in the quartz glass container 60, and the position of the light source was adjusted so that the distance between the quartz glass container 60 in contact with the sample and a xenon light source 62 (super bright 500 XEF-501S (manufactured by Tokina Corporation), 500 W, 25.0 A) was 2 cm. In addition, a cut filter 61 was used to cut light of 470 nm or less. The above results and the results of Example 1 obtained in Evaluation 1 are shown in FIG. 31. As shown in the figure, it was confirmed that the amount of hydrogen released increased with the addition of the hole scavenger.

### (Evaluation 6)

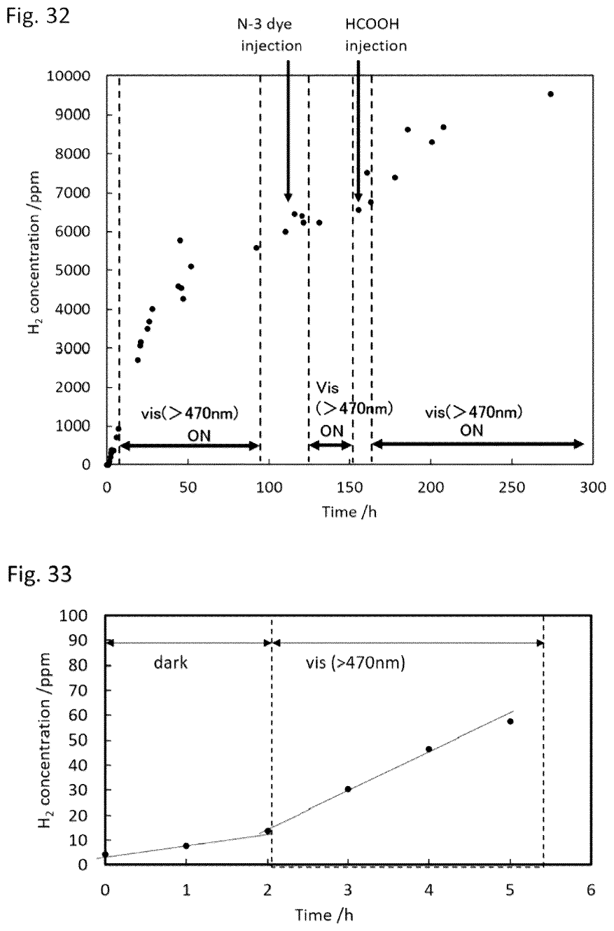

Regarding the composition of Example 1, the amount of hydrogen released was measured in the same manner as in Evaluation 1 except that the following operations were performed. Specifically, in the present evaluation 5, light irradiation was stopped 90 hours after visible light irradiation, and 1 mg of N3, which is a dye, was added. Then, after 5 hours of non-irradiation, visible light irradiation was performed again for 45.5 hours, and then the light irradiation was stopped, and 1 mL of formic acid, which is a proton donor, was added. Then, after 7.5 hours of non-irradiation time had elapsed, visible light irradiation was performed again. The amount of hydrogen released in this case is shown in FIG. 32. As shown in the figure, while no increase in the amount of hydrogen released was observed even with the addition of N3, an increase in the amount of hydrogen released was observed with the addition of formic acid. It was confirmed that the saturation of the amount of hydrogen released after about 100 hours of irradiation was not due to dye decomposition, but was due to the release of hydrogen from the hydrogen boride-containing sheet, and adding a proton donor could continuously generate hydrogen from the hydrogen boride-containing sheet.

### (Evaluation 7)

Regarding the composition of Example 5, the amount of hydrogen released was measured in the same manner as in Evaluation 1. The results are shown in FIG. 33. From the same figure, it was confirmed that the amount of hydrogen released was significantly increased by visible light irradiation compared to the case of non-irradiation.

### (Evaluation 8)

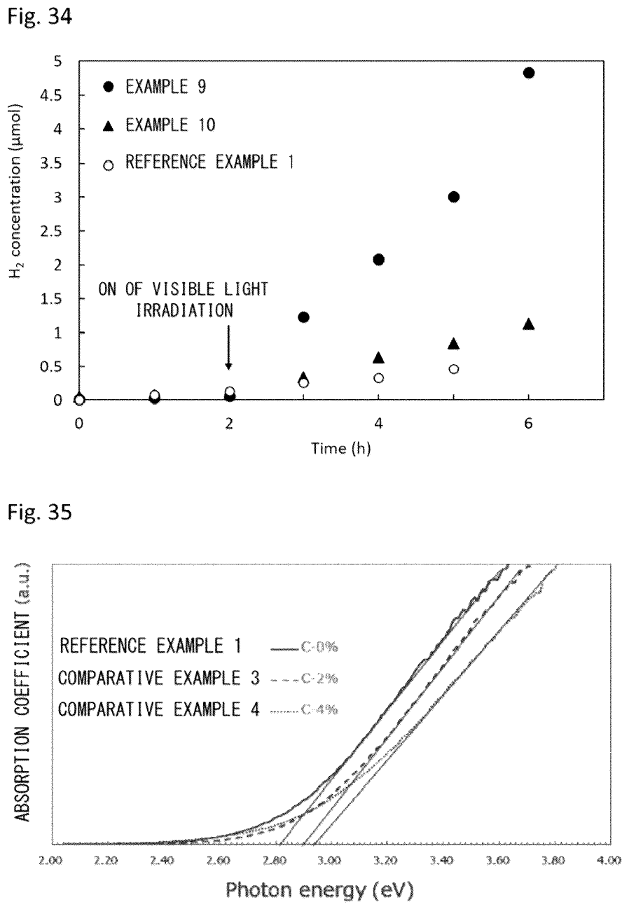

FIG. 34 shows the results of measuring the amount of hydrogen released for the powdery compositions of Examples 9 and 10 by irradiating them with visible light in nitrogen gas. Visible light irradiation was started at the timing indicated by the arrow in the figure. The figure also shows the result of Reference Example 1 (hydrogen boride-containing sheet to which no electron donor was added) for comparison. As shown in the figure, it was confirmed that the powdery present composition was irradiated with visible light, significantly increasing the amount of hydrogen released by visible light irradiation compared to the case of non-irradiation.

### (Evaluation 9)

The band gaps of the powdery products of Comparative Examples 3 and 4 were calculated by Tauc plot. The calculation results are shown in FIG. 35. The figure also shows the result of Reference Example 1 (hydrogen boride-containing sheet to which no electron donor was added) for comparison. As shown in the figure, it was confirmed that the hydrogen boride-containing sheet was doped with carbon, increasing the bandgap energy compared to a hydrogen boride-containing sheet to which no electron donor is added (C: 0%). That is, it was found that the hydrogen boride-containing sheet had a broadened bandgap for light absorption and thus could not absorb visible light. From this, it was found that simply doping the hydrogen boride-containing sheet with a different element such as carbon did not cause absorption of visible light.

This application claims priority based on Japanese Patent Application No. 2021-117864 filed on Jul. 16, 2021, and the entire disclosure thereof is incorporated herein.

1. A hydrogen boride-containing composition comprising:
a hydrogen boride-containing sheet having a two-dimensional network consisting of (BH)ₙ (n≥4, where n is an integer); and
an electron donor, wherein
at least a portion of the electron donor is supported on a surface of the hydrogen boride-containing sheet, and
electrons of the electron donor are supplied to the hydrogen boride-containing sheet by external stimulus, and hydrogen is generated from the hydrogen boride-containing sheet into which the electrons are injected.

2. The hydrogen boride-containing composition according to claim 1, wherein a LUMO (lowest unoccupied molecular orbital) or conduction band level of the electron donor is more negative than a conduction band level of the hydrogen boride-containing sheet.

3. The hydrogen boride-containing composition according to claim 1, wherein the electron donor is excited by visible light, and hydrogen is generated from the hydrogen boride-containing sheet by supplying of the excited electrons to the hydrogen boride-containing sheet.

4. The hydrogen boride-containing composition according to claim 1, wherein the electron donor is an organic compound.

5. The hydrogen boride-containing composition according to claim 1, wherein the electron donor has at least one of a carboxy group, a phosphono group, and a sulfonic acid group.

6. The hydrogen boride-containing composition according to claim 1, comprising a solvent.

7. The hydrogen boride-containing composition according to claim 1, further comprising a hole scavenger.

8. The hydrogen boride-containing composition according to claim 7, wherein a redox potential of the hole scavenger is more negative than a HOMO (highest occupied molecular orbital) or valence band level of the electron donor.

9. The hydrogen boride-containing composition according to claim 1, further comprising a proton donor.

10. The hydrogen boride-containing composition according to claim 9, wherein the proton donor is an acid.

11. A hydrogen generation system comprising the hydrogen boride-containing composition according to claim 1, the system comprising:
a hydrogen boride-containing composition;
a control unit configured to control on/off of external stimulus to the hydrogen boride-containing composition; and
a hydrogen generation unit configured to take out hydrogen to an outside.

12. A fuel cell system comprising:
the hydrogen generation system according to claim 11; and
a fuel cell to which hydrogen is supplied from the hydrogen generation system.
